(19) United States
(12) Patent Application Publication
(10) Pub. No.: US 2012/0316755 A1
(43) Pub. Date: Dec. 13, 2012

(54) CONTROL SYSTEM IMPLEMENTING POLARITY-SWITCHING WAVEFORMS

(76) Inventor: Daniel R. IBRAHIM, Metamora, IL (US)

(21) Appl. No.: 13/173,731

(22) Filed: Jun. 30, 2011

Related U.S. Application Data
(60) Provisional application No. 61/495,612, filed on Jun. 10, 2011.

(51) Int. Cl. F02D 41/26; H02P 31/00; F02D 41/30

(52) U.S. Cl. 701/103; 361/160

(57) ABSTRACT

A control system is disclosed. The control system may have an armature, windings associated with the armature, and at least one power supply. The control system may also have a controller in communication with the windings and the at least one power supply. The controller may be configured to direct a first current waveform having a first polarity into the windings during a first period of time to move the armature in a desired manner, and to direct a second current waveform having a second polarity into the windings during a second period of time to move the armature in the desired manner.

### RELATED APPLICATIONS

This application is based on and claims the benefit of priority from U.S. Provisional Application No. 61/495,612 by Daniel R. IBRAHIM, filed Jun. 10, 2011, the contents of which are expressly incorporated herein by reference.

### TECHNICAL FIELD

The present disclosure is directed to a control system and, more particularly, to a control system implementing polarity-switching waveforms.

### BACKGROUND

Common rail fuel injectors provide a way to introduce fuel from a common supply rail into the combustion chambers of an engine. Typical common rail fuel injectors include an actuating solenoid that opens a fuel injector nozzle when windings of the solenoid are energized with a particular current waveform to attract a metallic armature. Fuel is then injected into the combustion chamber as a function of the time period during which the windings remain energized with the waveform. An example of such a fuel injector is disclosed in U.S. Pat. No. 7,013,876 of Puckett et al. that issued on Mar. 21, 2006 (the '876 patent).

One problem associated with the type of fuel injector disclosed in the '876 patent involves residual magnetism within the stator and armature. That is, over time, the armature, being repeatedly exposed to a particular magnetic field, may develop magnetism that remains even after the windings of the solenoid are no longer energized with the current waveform. In addition, the magnetism within the armature may fluctuate depending on frequency and duration of operation. Residual magnetism, particularly fluctuating levels of residual magnetism, can cause the armature to move inconsistently when the windings of the solenoid are energized and de-energized. Inconsistent movement of the armature can negatively affect performance of the associated fuel injector and engine.

The control system of the present disclosure addresses one or more of the problems set forth above and/or other problems of the prior art.

### SUMMARY

One aspect of the present disclosure is directed to a method of controlling an armature. The method may include directing a first current waveform having a first polarity into windings associated with the armature during a first period of time to move the armature in a desired manner. The method may also include directing a second current waveform having a second polarity into the windings during a second period of time to move the armature in the desired manner.

Another aspect of the present disclosure is directed to a control system. The control system may include an armature, windings associated with the armature, and at least one power supply. The control system may also include a controller in communication with the windings and the at least one power supply. The controller may be configured to direct a first current waveform having a first polarity into the windings during a first period of time to move the armature in a desired manner, and to direct a second current waveform having a second polarity into the windings during a second period of time to move the armature in the desired manner.

Yet another aspect of the present disclosure is directed to a fuel control system for an engine having at least one combustion chamber. The fuel control system may include a source of pressurized fuel, and at least one fuel injector configured to inject the pressurized fuel from the source into the at least one combustion chamber. The fuel injector may have an armature, windings associated with the armature that are configured to move the armature when energized with a current waveform, and a valve element operatively connected to the armature. Movement of the valve element from a first position toward a second position initiates injection of pressurized fuel into the at least one combustion chamber. The fuel control system may also include at least one power supply, and a controller in communication with the windings of the fuel injector and with the at least one power supply. The controller may be configured to direct a first current waveform in a first direction through the windings during a first period of time to initiate a first injection event, and to direct a second current waveform through the windings in a second direction opposite the first direction during a second period of time to initiate a second injection event substantially identical to the first injection event.

### BRIEF DESCRIPTION OF THE DRAWINGS

FIG. 1 is a partial cross-sectional and diagrammatic illustration of an exemplary disclosed engine;

FIG. 2 is a partial cross-sectional and diagrammatic illustration of an exemplary disclosed fuel control system that may be used with the engine of FIG. 1; and

FIG. 3 is a control diagram for the fuel control system of FIG. 2.

### DETAILED DESCRIPTION

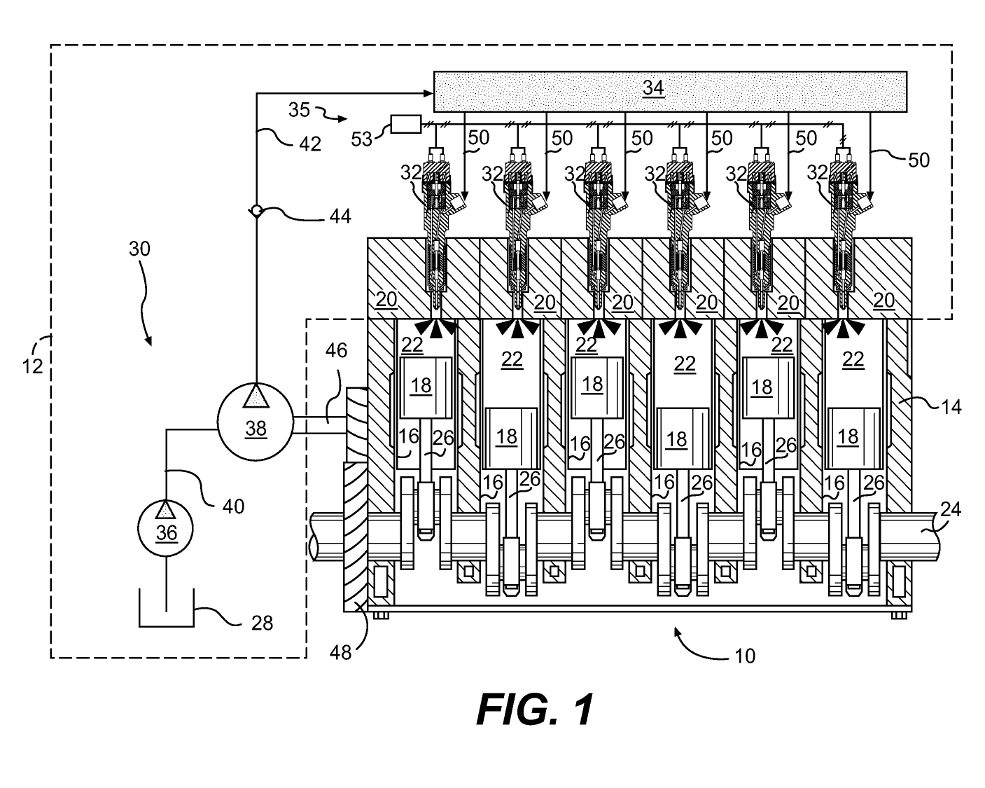

FIG. 1 illustrates an engine 10 and an exemplary embodiment of a fuel system 12. For the purposes of this disclosure, engine 10 is depicted and described as a four-stroke diesel engine. One skilled in the art will recognize, however, that engine 10 may be another type of internal combustion engine such as, for example, a gasoline or a gaseous fuel-powered engine. Engine 10 may include an engine block 14 that defines a plurality of cylinders 16, a piston 18 slidably disposed within each cylinder 16, and a cylinder head 20 associated with each cylinder 16.

Cylinder 16, piston 18, and cylinder head 20 may together form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or in another suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, a fuel pumping arrangement 30 configured to pressurize the fuel and direct the pressurized fuel to a plurality of fuel injectors 32 by way of a common rail 34, and a control system 35 that is functional to regulate operation of fuel injectors 32.

Fuel pumping arrangement 30 may include one or more pumping devices that function to increase the pressure of the fuel and direct one or more pressurized streams of fuel to common rail 34. In the disclosed example, fuel pumping arrangement 30 includes a low-pressure source 36 and a high-pressure source 38 disposed in series and fluidly connected by way of a fuel line 40. Low-pressure source 36 may be a transfer pump configured to provide low-pressure feed to high-pressure source 38. High-pressure source 38 may be configured to receive the low-pressure feed and to increase the pressure of the fuel to the range of about 30-300 MPa. High-pressure source 38 may be connected to common rail 34 by way of a fuel line 42. A check valve 44 may be disposed within fuel line 42 to provide for a unidirectional flow of fuel from fuel pumping arrangement 30 to common rail 34.

One or both of low- and high-pressure sources 36, 38 may be operably connected to engine 10 and driven by crankshaft 24. Low- and/or high-pressure sources 36, 38 may be connected with crankshaft 24 in any manner readily apparent to one skilled in the art where a rotation of crankshaft 24 will result in a corresponding rotation of a pump drive shaft. For example, a pump driveshaft 46 of high-pressure source 38 is shown in FIG. 1 as being connected to crankshaft 24 through a gear train 48. It is contemplated, however, that one or both of low- and high-pressure sources 36, 38 may alternatively be driven electrically, hydraulically, pneumatically, or in another appropriate manner.

Fuel injectors 32 may be disposed at least partially within cylinder heads 20 and connected to common rail 34 by way of a plurality of fuel lines 50. Each fuel injector 32 may be operable to inject an amount of pressurized fuel into an associated combustion chamber 22 at predetermined timings, fuel pressures, and fuel flow rates. The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection to create a reducing atmosphere for aftertreatment regeneration. Other injection timing strategies may also be utilized, as desired.

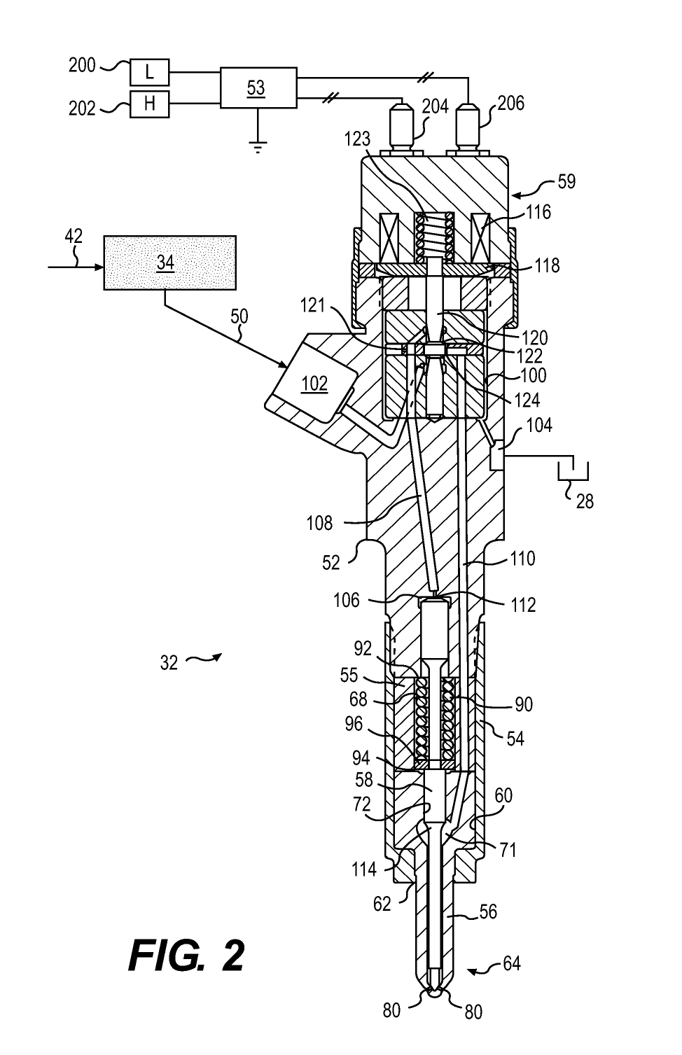

As illustrated in FIG. 2, each fuel injector 32 may be a closed nozzle unit fuel injector. Specifically, each fuel injector 32 may include an injector body 52, a housing 54 operably connected to injector body 52, a guide 55 disposed within housing 54, a nozzle member 56, a needle valve element 58 disposed at least partially within guide 55 and nozzle member 56, and a solenoid actuator 59 connected to an end of body 52 opposite nozzle member 56. It is contemplated that additional components may be included within fuel injector 32 such as, for example, restricted orifices, pressure-balancing passageways, accumulators, and other injector components known in the art.

Injector body 52 may be a generally cylindrical member configured for assembly within cylinder head 20 and having one or more passageways. Specifically, injector body 52 may include a central bore 100 configured to receive solenoid actuator 59, a fuel inlet 102 and fuel outlet 104 in communication with central bore 100, and a control chamber 106. Control chamber 106 may be in communication with central bore 100 via a control passageway 108 and in direct communication with needle valve element 58. Control chamber 106 may be selectively drained of or supplied with pressurized fuel to affect motion of needle valve element 58. Injector body 52 may also include a supply passageway 110 that fluidly communicates central bore 100 with nozzle member 56.

Housing 54 may be a generally cylindrical member having a central bore 60 for receiving guide 55 and nozzle member 56, and an opening 62 through which a tip end 64 of nozzle member 56 protrudes. A sealing member such as, for example, an o-ring (not shown) may be disposed between guide 55 and nozzle member 56 to restrict fuel leakage from fuel injector 32.

Guide 55 may also be a generally cylindrical member having a central bore 68 configured to receive needle valve element 58 and a return spring 90. Return spring 90 may be disposed between a stop 92 and a seating surface 94 to axially bias needle valve element 58 toward tip end 64 of nozzle member 56. A spacer 96 may be disposed between return spring 90 and seating surface 94 to reduce wear of the components within fuel injector 32. It is contemplated that an additional spacer (not shown) may be disposed between return spring 90 and stop 92 to further reduce component wear.

Nozzle member 56 may likewise embody a generally cylindrical member having a central bore 72 and a pressure chamber 71. Central bore 72 may be configured to receive needle valve element 58. Pressure chamber 71 may hold pressurized fuel supplied from supply passageway 110 in anticipation of an injection event. Nozzle member 56 may also include one or more orifices 80 to allow the pressurized fuel to flow from pressure chamber 71 through central bore 72 into combustion chambers 22 of engine 10, as needle valve element 58 is moved away from orifices 80.

Needle valve element 58 may be an elongated cylindrical member that is slidingly disposed within guide 55 and nozzle member 56. Needle valve element 58 may be axially movable between a first position at which a tip end of needle valve element 58 inhibits a flow of fuel through orifices 80, and a second position at which orifices 80 are open to allow a flow of fuel into combustion chamber 22. It is contemplated that needle valve element 58 may be a multi-member element having a needle member and a piston member or a single integral element, as desired.

Needle valve element 58 may have multiple driving hydraulic surfaces. For example, needle valve element 58 may include a hydraulic surface 112 tending to drive needle valve element 58 with the bias of return spring 90 toward a first or orifice-blocking position when acted upon by pressurized fuel. Needle valve element 58 may also include a hydraulic surface 114 that opposes the bias of return spring 90 to drive needle valve element 58 in the opposite direction toward a second or orifice-opening position when acted upon by pressurized fuel.

Solenoid actuator 59 may be disposed at an end of body 52 opposite nozzle member 56 and operable to vary the forces acting on needle valve element 58, thereby initiating and terminating operations of fuel injector 32. In particular, solenoid actuator 59 may include windings 116 of a suitable shape and size through which current may flow to establish a magnetic field. Solenoid actuator 59 may also include an armature 118 associated with windings 116 and operatively connected to a two-position control valve element 120. When windings 116 are energized (i.e., when a current waveform is passed through windings 116), the magnetic field established by windings 116 may urge armature 118 and connected control valve element 120 against the bias of a return spring 123 from a first or non-injecting position to a second or injecting position. For example, control valve element 120 may be moved between a lower seat 122 and an upper seat 124. In the non-injecting position (i.e., when control valve element 120 is resting against lower seat 122) fuel may flow from fuel inlet 102 through control passageway 108 into control chamber 106. As fuel pressure builds within control chamber 106, the downward force generated at hydraulic surface 112, combined with the force of return spring 90, may overcome the upward force at hydraulic surface 114, thereby causing needle valve element 58 to close orifices 80 and terminate fuel injection. In the injecting position (i.e., when control valve element 120 is resting against upper seat 124) fuel may flow from control chamber 106 to tank 28 via a restricted orifice 121, central bore 100, and fuel outlet 104. When fuel from control chamber 106 drains to tank 28, the force on hydraulic surface 112 may diminish and the upward force at hydraulic surface 114 may urge needle valve element 58 against return spring 90, thereby opening orifices 80 and initiating fuel injection into combustion chambers 22. When de-energized, return spring 123 may return armature 118 and control valve element 120 to the non-injecting position.

Control system 35 may include components that facilitate control of each fuel injector 32. In particular, control system 35 may include a controller 53 that selectively communicates a low voltage source 200 (e.g., a battery of engine 10) and a high voltage source 202 (e.g., a capacitor circuit associated with engine 10) with terminal ends 204, 206 of windings 116 within each of fuel injectors 32 to control a fuel injection timing, amount, and/or duration by communicating a current waveform or sequence of current waveforms to solenoid actuator 59 of each fuel injector 32.

Controller 53 may embody a single microprocessor or multiple microprocessors that include a means for controlling an operation of fuel injector 32. Numerous commercially available microprocessors can be configured to perform the functions of controller 53. It should be appreciated that controller 53 could readily embody a general work machine or engine microprocessor capable of controlling numerous work machine or engine functions. Controller 53 may include all the components required to run an application such as, for example, a memory, a secondary storage device, and a processor, such as a central processing unit or any other means known in the art for controlling fuel injectors 32. Various other known circuits may be associated with controller 53, including power supply circuitry, signal-conditioning circuitry, solenoid driver circuitry, communication circuitry, switching circuitry, and other appropriate circuitry.

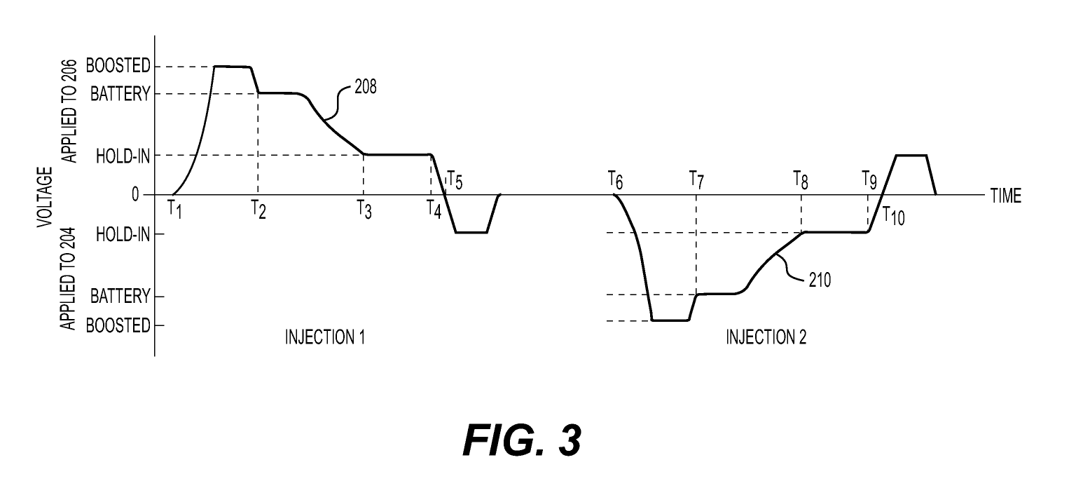

The timing and voltage level of the current induced within windings 116 by controller 53 may be varied to affect fuel injection. For example, as illustrated in the control diagram of FIG. 3, a first current may be induced within windings 116 at a time T1 that initiates movement of control valve element 120 toward the injecting position during a first injection event. The first current may be induced within windings 116 by communicating a boosted voltage (e.g., a voltage from high voltage source 202) to terminal end 204 of windings 116, while simultaneously grounding terminal end 206. The first current may flow from terminal end 204 to terminal end 206 in a first direction through windings 116. The voltage of the first current may be sufficiently high to overcome effects of inertia within control valve element 120.

At a time T2, the voltage applied to terminal end 204 may be reduced to induce a second current within windings 116 that continues to move control valve element 120 toward the injecting position. Because control valve element 120 may already be in motion at time T2, the voltage required of the second current to continue the motion may be less than the voltage required of the first current to initiate the motion. The first current may be induced within windings 116 by communicating low voltage source 200 to terminal end 204, while simultaneously grounding terminal end 206.

At a time T3, the voltage passing through windings 116 may be further reduced to induce a third or hold-in current that continues for the duration of fuel injection until a time T4. Controller 58 may reduce the voltage of the third current by selectively chopping (i.e., turning on and off) power received from low-voltage source 200 through any chopping procedure known in the art. The third current may have a voltage just high enough to overcome the force of return spring 123 and hold control valve element 120 in the injecting position.

Each of the second and third currents may have a voltage less than the previous current (i.e., the second current may have a voltage less than the first current, and the third current may have a voltage less than the second current) to conserve energy and to reduce the cooling requirements of solenoid actuator 59, while simultaneously meeting the force requirements of control valve element 120. At time T4, the voltage applied to terminal end 204 may be reduced even more, to about zero, to allow return spring 116 to move armature 118 and control valve element 114 to the non-injecting position, thereby terminating fuel injection. For the purposes of this disclosure, the combination of voltage levels induced within windings 116 from time T1 through time T4, together with the time durations of voltage level, may be considered a first waveform 208 that is used to produce a first injection event.

In some embodiments, first waveform 208 may include an additional current of reversed polarity beginning at a time T5 that is only briefly applied to solenoid actuator 59 before returning the current to about zero. To reverse the polarity of the current within solenoid actuator 59, controller 58 may communicate a voltage from low voltage source 200 to terminal end 206, while simultaneously grounding terminal end 204. By communicating voltage to terminal end 206, while simultaneously grounding terminal end 204, the current passing through windings 116 may pass in a reverse direction relative to the other currents of first waveform 208. This short duration of reversed polarity current initiating at time T5 may function to quickly drain current out of solenoid actuator 59 and thereby reduce delays in injection termination due to induction and eddy currents within solenoid actuator 59.

A second waveform 210 is also shown FIG. 3. Second waveform 210 may include a combination of currents induced within windings 116 from a time T6 through a time T10 that, together, produce a second injection event during operation of engine 10 that is substantially identical to the first injection event. As can be seen in FIG. 3, the magnitudes and durations of the different voltage levels of second waveform 210 may be substantially identical to the magnitudes and durations of the different voltage levels of first waveform 208. However, the polarity of the second current waveform 210 may be opposite the polarity of first waveform 208. That is, the voltage from low- and high-voltage sources 200, 202 may be directed by controller 53 during application of second waveform 210 into windings 116 via terminal end 206 (instead of terminal end 204), while terminal end 204 may be grounded during application of second waveform 210 (instead of terminal end 206). Accordingly, during application of second waveform 210, current may flow through windings 116 in a direction opposite the current flow direction during application of first waveform 208.

Controller 53 may selectively direct first and second waveforms 208, 210 through windings 116 of injector 32 during first and second periods of time, respectively, to inject fuel into combustion chambers 22 (referring to FIG. 1) in a desired manner, while also reducing a likelihood of residual magnetism within armature 118. That is, the use of first waveform 208 may generate a first field of magnetism passing through armature 118 in a first direction that causes armature 118 to move in the desired manner and initiate fuel injections, while second waveform 210 may generate a second field of magnetism passing through armature 118 in a second direction substantially opposite to the first direction to cause the desired movement of armature 118. By utilizing both first and second waveforms 208, 210, residual magnetism created within armature 118 by use of first waveform 208 may be substantially removed by the reversed polarity of second waveform 210, and vice versa. In one example, controller 53 may alternate the use of first and second waveforms 208, 210 for consecutive injection events. In another example, controller 53 may primarily utilize first waveform 208, and only substitute with second waveform 210 on a periodic basis after a threshold amount of residual magnetism is determined to have been created within armature 118 or after a threshold number of uses of first waveform 208. By only utilizing second waveform 210 on an as-need or periodic basis, the computing complexity, cost, and/or wear of controller components may be reduced.

### INDUSTRIAL APPLICABILITY

The control system of the present disclosure has wide application in a variety of different technologies. In particular, any device that utilizes a solenoid actuator where residual magnetism within the actuator's armature is undesired may benefit from the disclosed control system. However, the disclosed control system finds particular applicability within engines, specifically within fuel injectors of engines, where performance consistency and accuracy is both critical and negatively affected by residual magnetism. In these applications, residual magnetism of the fuel injector's armature may be reduced, if not completely eliminated, by selectively switching the polarity of waveforms directed through the associated windings.

It will be apparent to those skilled in the art that various modifications and variations can be made to the fuel injector of the present disclosure without departing from the scope of the disclosure. Other embodiments will be apparent to those skilled in the art from consideration of the specification and practice of the fuel injector disclosed herein. It is intended that the specification and examples be considered as exemplary only, with a true scope of the disclosure being indicated by the following claims and their equivalents.

What is claimed is:

1. A method of controlling an armature, comprising:
directing a first current waveform having a first polarity into windings associated with the armature during a first period of time to move the armature in a desired manner; and
directing a second current waveform having a second polarity into the windings during a second period of time to move the armature in the desired manner.

2. The method of claim 1, wherein the first and second current waveforms have substantially identical voltage magnitudes and durations.

3. The method of claim 2, wherein each of the first and second current waveforms includes a least a first duration of voltage at a first level, a second duration of voltage at a second level lower than the first level, and a third duration of voltage at a third level lower than the second level.

4. The method of claim 3, wherein each of the first and second current waveforms further includes a final duration of voltage having a polarity reversed relative to the first, second, and third durations.

5. The method of claim 1, wherein directing the second current waveform having a second polarity into the windings includes directing the second current waveform through the windings in a direction opposite the first current waveform.

6. The method of claim 5, further including alternating use of the first and second waveforms.

7. The method of claim 5, further including only using the second current waveform after a threshold number of times using the first current waveform.

8. The method of claim 1, wherein the second current waveform is sufficient to remove residual magnetism caused by use of the first current waveform.

9. A control system, comprising:
an armature;
windings associated with the armature;
at least one power supply; and
a controller in communication with the windings and the at least one power supply, the controller being configured to:
direct a first current waveform having a first polarity into the windings during a first period of time to move the armature in a desired manner; and
direct a second current waveform having a second polarity into the windings during a second period of time to move the armature in the desired manner.

10. The control system of claim 9, wherein the first and second current waveforms have substantially identical voltage magnitudes and durations.

11. The control system of claim 10, wherein each of the first and second current waveforms includes a least a first duration of voltage at a first level, a second duration of voltage at a second level lower than the first level, and a third duration of voltage at a third level lower than the second level.

12. The control system of claim 11, wherein each of the first and second current waveforms further includes a final duration of voltage having a polarity reversed relative to the first, second, and third durations.

13. The control system of claim 9, wherein the controller is configured to direct the second current waveform having a second polarity into the windings by directing the second current waveform through the windings in a direction opposite the first current waveform.

14. The control system of claim 13, wherein the controller is further configured to alternate use of the first and second waveforms.

15. The control system of claim 13, wherein the controller is further configured to only use the second waveform after a threshold number of times using the first waveform.

16. The control system of claim 9, wherein the at least one power supply includes a high voltage power supply and a low voltage power supply.

17. A fuel control system for an engine having at least one combustion chamber, the fuel control system comprising:
a source of pressurized fuel;
at least one fuel injector configured to inject the pressurized fuel from the source into the at least one combustion chamber, the at least one fuel injector including:
an armature;
windings associated with the armature and configured to move the armature when energized with a current waveform; and
a valve element operatively connected to the armature, wherein movement of the valve element from a first position toward a second position initiates injection of pressurized fuel into the at least one combustion chamber;
at least one power supply; and
a controller in communication with the windings of the at least one fuel injector and with the at least one power supply, the controller being configured to:
direct a first current waveform in a first direction through the windings during a first period of time to initiate a first injection event; and
direct a second current waveform through the windings in a second direction opposite the first direction during a second period of time to initiate a second injection event substantially identical to the first injection event.

18. The fuel control system of claim 17, wherein each of the first and second current waveforms includes a least a first duration of voltage at a first level, a second duration of voltage at a second level lower than the first level, and a third duration of voltage at a third level lower than the second level.

19. The fuel control system of claim 18, wherein each of the first and second current waveforms further includes a final duration of voltage having a polarity reversed relative to the first, second, and third durations.

20. The fuel control system of claim 17, wherein the controller is further configured to alternate use of the first and second waveforms.
